(19) United States
(12) Patent Application Publication
(10) Pub. No.: US 2003/0147120 A1
(43) Pub. Date: Aug. 7, 2003

(54) Method and system for recycling pump power in an erbium doped fiber amplifier

(76) Inventors: Dong-Xue Wang, Lake Zurich, IL (US); George Bodeep, Suwanee, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/326,768

(22) Filed: Dec. 20, 2002

Related U.S. Application Data
(60) Provisional application No. 60/343,296, filed on Dec. 22, 2001.

(51) Int. Cl. H01S 3/00

(52) U.S. Cl. 359/333

(57) ABSTRACT

A WDM device separates an information signal and a pump power signal, each having a different wavelength from the other, from a combined signal after the information signal has been amplified by a first fiber amplifier stage. The pump power signal is isolated so that is does not co-propagate with the information signal to another fiber amplifier stage, or from an output of the amplifier assembly. The isolated pump power signal is routed to another WDM device that combines this recycled pump power signal and the information signal provided from the first stage. The recycled pump power is used to stimulate dopant of the next stage fiber amplifier to cause amplification of the information signal above the level provided by the first stage.

### CROSS REFERENCE TO RELATED APPLICATION

This application claims the benefit of priority under 35 U.S.C. 119(e) to Wang, et al., U.S. provisional patent application No. 60/343,296 entitled “Pump Power Recycle In Gain-Flattened EDFA”, which was filed Dec. 22, 2001, and is incorporated herein by reference.

### FIELD OF THE INVENTION

This invention relates, generally, to erbium-doped fiber amplifiers (“EDFA”), and more particularly to reducing interstage loss within an EDFA.

### BACKGROUND

Rare-earth elements, preferably erbium, have been used to dope fiber for use in optical fiber amplifiers, which may comprise multiple stages of erbium doped fibers. In these multiple stage arrangements, it is desirable to reduce interstage loss at the pump wavelength as much as possible. In some cases this may increase the cost of the interstage network.

Typically, each stage in a multi-stage fiber amplifier arrangement often includes a source for supplying a power supply signal at a particular wavelength. This source is typically referred to as a “pump” because it injects energy at a particular wavelength into an input of a fiber amplifier through a coupling, such as a fused biconic coupler, for example, which typically merges the input information signal and the pump power signal before being input into the doped fiber. The pump power stimulates erbium, or other doping material, in the fiber amplifier to boost the power level of an information signal at the amplifier's input.

The fused biconic coupler typically has two input fibers and an output fiber, one of the input fibers being fused to the other fiber, both fibers being cone-shaped at their intersection such that the two fibers merge together along a tapered intersection surface. Such couplers are known in the art and need not be discussed further with respect to their physical description.

Each stage of a multistage amplifier typically comprises a loop of doped fiber of a predetermined length, a pump device having an output fiber, an input signal fiber and a coupler, such as a biconic coupler, for example, for merging the signals from the input signal fiber and the pump output fiber together. The merged signal as then fed into an input end of the doped fiber. Accordingly, a two-stage fiber amplifier typically comprises two of each of these components.

Although this arrangement typically provides satisfactory performance, it is desirable to reduce the number of discrete components as much as possible to lower the cost of the amplifier. Since each pump is typically an active component that significantly contributes to the overall cost of an amplifier, single stage amplifiers are often used in certain applications to lower network system costs. However, a single stage amplifier typically does not provide as much signal gain as an amplifier having two or more stages.

Thus, there is a need for a method and system for implementing a fiber amplifier that uses one pump that can provide signal gain of a magnitude similar to that of a multistage amplifier having more than one pump.

### SUMMARY

It is an object to provide a method and system for implementing a fiber amplifier that provides a signal gain of magnitude similar to an amplifier arrangement having heretofore a larger number of stages. For example, it is an object to provide a fiber amplifier having a single pump section to provide signal gain of magnitude similar to a two stage fiber amplifier. The output of a single pump source is used to stimulate doped fiber of two different amplifier stages. As in a conventional multi-stage amplifier, a pump signal is coupled with an information signal to be amplified, before the combined signal is fed into the typically erbium-doped fiber. As discussed above, a biconic coupler is typically used for merging the pump signal and the information signal into a combined signal before amplification thereof.

Another coupler, typically of the biconic style, is used in the reverse direction, as compared to the other couplers (in other words, used as a splitter instead of a coupler), to split apart the pump power signal at one wavelength and the information signal at another wavelength from the combined signal after it has been amplified by the corresponding doped fiber. Thus, after the combined signal has been amplified, the pump power signal is removed from the amplified combined signal and routed to another stage for use as that stage's pump power source. This process may be referred to as “recycling” of the pump power wavelength generated by the single pump of the first stage, because the pump power signal, extracted after amplification in the first stage, is used as the pump source in the next stage instead of a new signal from another pump.

Generally described is a first means for amplifying an optical signal, the first amplifying means including a silicon-based fiber doped with a rare-earth element. A means for providing a pump power signal to stimulate the rare-earth element of the first amplifying means into an energy state higher than the valence state is also provided. A means for splitting a: combined signal into a pump power signal and an information signal passes the information signal wavelength to an interstage network and isolates the first stage pump signal wavelength from the interstage network. A routing means routes the isolated pump power signal to a second stage amplifying means so that the isolated pump power signal can be used to stimulate a rare earth element of the second stage amplifying means into an energy state higher than the valence state, thus reducing the pump power required in the second stage or eliminating the need for a second pump device.

A method for amplifying an optical signal is also provided, the method comprising combining an information signal having a first wavelength and a pump power signal having a second wavelength into a combined signal at a first amplifier stage. A first stage optical fiber doped with a rare-earth element amplifies the combined signal. After amplification of the combined signal, the amplified information signal is separated from the combined signal, so that the separated information signal can be provided to an input port of an interstage network. In addition to the input port, the interstage network also includes an output port. Separating the amplified signal from the combined signal also results in the pump power signal being separated from the combined signal. This separated pump power signal is isolated to substantially prevent it from being passed to the interstage network, while allowing it to be passed to a second stage optical fiber. The isolated pump power signal from the first amplifier stage is combined with the amplified information signal from the output port of the interstage network, thus functioning as the pump power source of the second amplifier stage.

### BRIEF DESCRIPTION OF DRAWINGS

FIG. 1 illustrates a schematic of a typical fiber amplifier having two pumps corresponding to two fiber amplifier stages.

FIG. 2 illustrates a schematic of a fiber amplifier that uses a single pump to stimulate two or more doped fiber elements in two or more corresponding amplifier stages.

FIG. 3 illustrates a process for using single pump to provide pump power to two or more stages of an optical fiber amplifier.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the 'substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof. Furthermore, while some aspects of the present invention are described in detail herein, no specific interstage network arrangement, device for providing pump power, controller system, or monitor and detection system, for example, is required to be used in the practicing of the present invention. Indeed, selection of such parts and components would be within the routine functions of a designer skilled in the art.

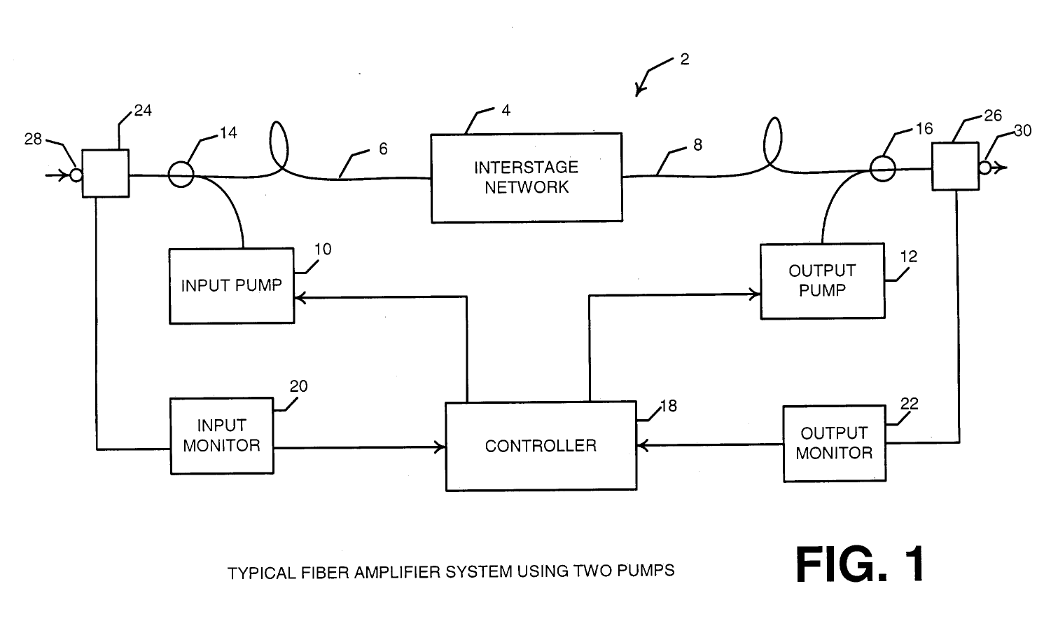

Turning now to the figures, FIG. 1 illustrates a fiber amplifier system 2. The amplifier may comprise an interstage network 4, such as, for example, a gain-flattening filter network for compensating for the inherent transfer characteristics that are typical in a doped fiber amplifier. The network 4 is disposed inline between a first amplifier fiber 6 and a second output amplifier fiber 8. Erbium is preferably used to dope fibers 6 and 8, although other doping materials, typically rare-earth elements, may be used.

Driving the amplifier 2 is first pump 10 and second pump 12, the first pump being coupled to first fiber 6 by first directional coupler 14 and the second pump being coupled to the second fiber 8 by second directional coupler 16. The first pump 10 and the second pump 12 may be controlled by micro controller 18, which can automatically adjust the bias power of each of the pumps individually yet simultaneously. Micro controller 18 adjusts the bias power of the pumps based on signals received from first monitor 20 and second monitor 22. First monitor 20 and second monitor 22 may typically comprise optical-electrical converters that receive optical signals from first power tap 24 and second power tap 26 respectively. First power monitor 20 and second power monitor 22 may each typically comprise a PIN diode or other optical sensor known in the art. First power tap 24 splits the power—and directs a portion, approximately 1%, to monitor 20—of an optical signal that is received by amplifier 2 at first port 28 and second power tap 26 splits the power of the output signal from the amplifier at second port 30, similarly routing approximately 1% to monitor 22.

First pump 10 provides an amount of gain to the input signal, and second pump 12 increases the output above the level provided by the first pump alone, so that the overall gain is higher than the gain that would result from using only a single pump. Thus, each fiber amplifier 6 and 8 is stimulated by pumps 10 and 12 respectively so that some electrons of the erbium, or other dopant, of each fiber are elevated to a heightened energy state, thereby causing the input signal pat port 28 to be amplified. This stimulation process is known in the art, and therefore, will not be discussed in more detail here. The salient point is that a pump power signal of a certain wavelength—typically approximately 980 nm is chosen to avoid conflict with the wavelength of the signal to be amplified, such wavelength typically being approximately 1550 nm—is used to stimulate electrons in the valance shell of the dopant material into a heightened energy state. When these electrons return to their valance state, photons are emitted at the input signal wavelength, thereby amplifying the input signal power.

The pump power signal is used to stimulate electrons of the dopant material into a heightened energy state, thereby facilitating the use of the potential energy of the elevated state of the electrons to boost the signal strength of the input signal. Since all of the power of the pump power signal is not used to elevate the electrons, the remaining power from a given pump may typically be unused.

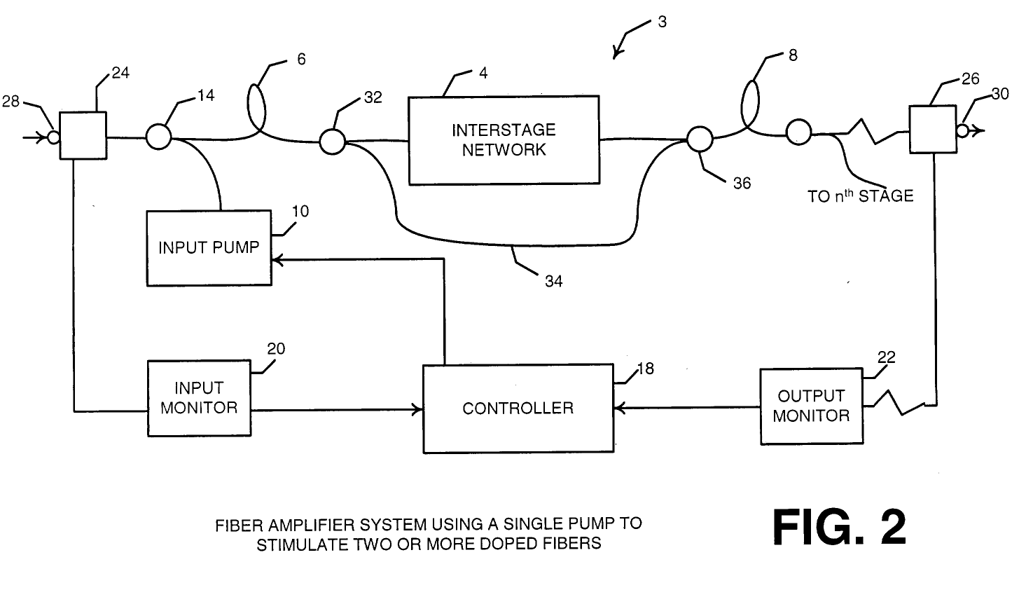

Turning now to FIG, 2. a system is illustrated where the remaining power from a pump may be used, or recycled, to stimulate the electrons of another doped fiber, without the use of another corresponding pump. The components used in amplifier 3 are similar to those used in amplifier 2 shown in FIG. 1, except that second pump 12 is not used in the amplifier of FIG. 2. Instead, separating means 32 separates the input signal from the pump power signal and isolates the pump power signal so that it is not passed to interstage network 4. The isolated pump power signal is routed to the second stage of the amplifier via link 34, which provides the pump power signal to the second stage at combiner 36.

To separate and isolate the unused pump power, separating device 32 may comprise a WDM device known in the art. Such devices are typically used to either split a combined signal comprising more than one wavelength into the individual wavelength signals at corresponding output ports, or to combine a plurality of signals, each having a different wavelength into a combined signal. Indeed, coupler 14 may comprise such a device. WDM devices are desirable because of their low insertion loss characteristic.

After the input signal power has been increased in fiber 6 by photons being emitted due to the input signal impinging on the elevated energy state electrons as they return to their valance state, WDM device 32 separates the input wavelength signal from the pump wavelength signal. The pump power wavelength signal is isolated so that only the input wavelength signal passes to interstage network 4.

The pump wavelength power is then routed from separator 32 to another WDM device, combiner 36, so that electrons of dopant material of fiber 8 are raised from their valance state to an elevated energy state. Thus, when the input wavelength signal from the output of interstage network 4 is applied to fiber 8, the power level of the input signal is magnified as the excited electrons of the fiber return to their valance state. Thus, the pump power from pump 10 is used to raise electrons in both fibers 6 and 8 to an elevated state, thereby negating the need for a second pump to provide power to the second stage, as depicted in the schematic of FIG. 1.

The arrangement of components shown in FIG. 2 provides a benefit in that a WVDM device typically contributes a lower insertion loss into an optic circuit as opposed to a splitter/coupler. Pump power from pump 10 could be used to stimulate dopant material of fiber 8 by using a splitter to remove some of the pump power before it is injected into the circuit at coupler 14. In such a scenario, the splitter would serve the function of separator 32 shown in FIG. 2 and would route the portion of pump power not injected at coupler 14 to combiner 36 for stimulation of fiber 8. However, since a splitter, which merely divides an input signal into a plurality of signal having the same wavelength(s) as the input signal, typically has a higher insertion loss than does a WDM device, less of the power that is not routed to coupler 14 would arrive at combiner 36. Therefore, by using a WDM device for separator 32 to isolate the pump power wavelength from the combined signal after it has been through fiber 6, more pump signal wavelength power reaches fiber 8, resulting in higher overall gain of amplifier 3 than if a splitter were used. It will be appreciated that a WDM device placed between pump 10 and coupler 14 would not provide the same function that a splitter would at the same point in the circuit, because pump power could then only be routed to either coupler 14 or combiner 36, but not both.

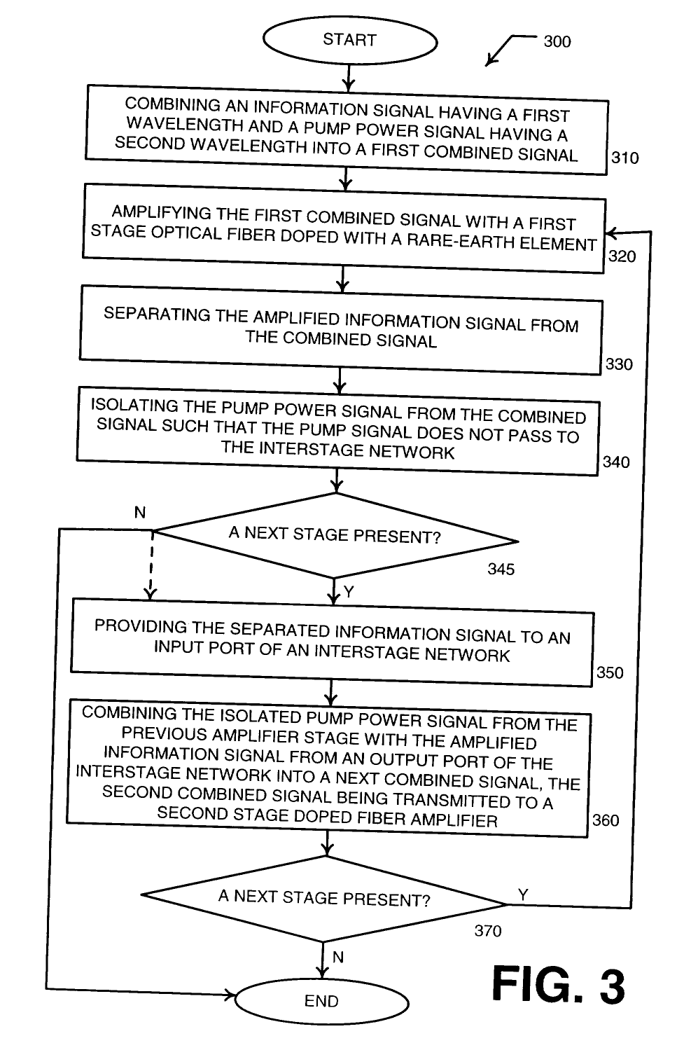

Turning now to FIG. 3, a flow chart illustrates a process 300 for using a single pump to provide pump power to two stages of an optical fiber amplifier. After process 300 starts, an information signal to be amplified is received by the amplifier. The information carrying signal may typically be a signal having a 1550 nm carrier that is modulated by the information being carried. The information signal is combined with a signal from a pump device, the pump signal may contain energy at a single wavelength, typically 980 nm, for example.

The pump power signal is combined at step 310 such that energy contained therein is injected into an optical fiber, typically doped with erbium or some other rare earth element. The pump signal energy forces valance electrons within the doping material to an elevated energy state. As the information signal energy passes the elevated-state electrons, the electrons drop back to their valance state, and in doing so, emit photons corresponding to the energy of the information signal, thus resulting in an information signal having a higher power following amplification at step 320 than before.

After the signal has been amplified, the combined signal has greater energy at the information signal wavelength, but less energy at the pump signal wavelength than was injected by the pump, as some of the original pump signal energy was used to elevate the valance electrons to the heightened energy state. However, although there is less pump wavelength energy, there is still a useful amount, as all of the pump signal energy is not used to elevate the valance electrons. Thus, the remaining pump wavelength energy can be separated from the information signal wavelength energy at step 330 using a WDM device.

When the two component wavelengths of the combined signal are separated, the pump wavelength signal energy is isolated at step 340 so that little, if any, energy at this wavelength is passed at step 350 to an interstage network, if present, that may be incorporated into the fiber amplifier arrangement. If no interstage network is present, the information signal may be routed directly to a next stage in the amplifier assembly.

The isolated remaining pump wavelength is routed from the isolating device and provided to a combiner of the next stage in the amplifier assembly. Similar to step 310, at the next stage, the combiner combines at step 360 the remaining pump power with the information signal from either the interstage network, or, if none, then directly from the previous stage. The combined pump power signal is used to stimulate valance electrons in the dopant material of the fiber amplifier of this next stage.

It will be appreciated that, although a two-stage amplifier is illustrated in FIG. 2, an amplifier may comprise more than two stages. Thus, in step 360, for example, the terminology “previous stage” is used to refer to a preceding stage, and the term next stage is used in reference to the stage following the preceding stage. In a two-stage amplifier, for example, the first stage is the preceding stage in reference to the second stage, which is the next stage in reference to the first stage. Accordingly, if there are more than two stages, the process 300 determines at step 370 that another step exists, and the process returns to step 320, wherefrom the process continues. If there is not at least one additional stage, the process ends.

It will also be appreciated that when the process returns from step 370 to step 320, instead of a first combined signal, the combined signal to be amplified will be a third or fourth, etc. combined signal. It is noted that between steps 340 and 350, a determination may be made at step 345 whether the information signal is to be sent to a next stage. If so, the process continues to step 350, if not, the process may end.

Step 345 is shown with a dashed line from the N output to indicate that even if there is not an additional stage, a WDM device may be used nevertheless to isolate the pump wavelength from the information wavelength at the last stage such that only the information signal is passed from the fiber amplifier assembly to the remainder of the network at step 350. It will be further appreciated that if no other next stage is present, the amplifier will not provide a pump signal wavelength to be combined with the information signal at step 360. Thus, only the information signal will be passed to the remainder of the network. However, if the remainder of the network is configured to receive a combined signal, the process may continue through steps 350 and 360, with a combined signal being provided to the remainder of the network at step 360.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A pump-power recycling amplifier comprising:
first stage means for amplifying an optical information signal, the first amplifying means including a silicon fiber doped with a rare-earth element;
means for providing a pump power signal to stimulate valance electrons of the rare-earth element into an energy state higher than their valence state;
means for separating a combined pump power signal and an information signal into constituent signals such that each signal is isolated from the other at respective outputs of the splitting means; and
means for routing the isolated pump power signal to a next stage amplifying means, the isolated pump power signal being used to stimulate a rare earth element of the next stage amplifying means into an energy state higher than the valence state.

2. The amplifier of claim 1 further comprising an interstage network between amplifier stages.

3. The amplifier of claim 2 wherein the separating means further includes means for passing the isolated information signal to the interstage network.

4. The amplifier means of claim 1 wherein the separating means is a WDM device.

5. The amplifier of claim 1 further comprising a means for combining the isolated pump power signal and the isolated information signal at the next stage amplifying means.

6. The amplifier of claim 5 wherein the combining means includes a WDM device.

7. A method for amplifying an optical information signal of a first wavelength, wherein the optical information signal has been combined with a pump power signal of a second wavelength into a first combined signal, comprising:
amplifying the combined signal with a first stage optical fiber doped with a rare-earth element;
separating the combined pump power signal and information signal into constituent signals such that each signal is isolated from the other at respective outputs of the separating means; combining at a next stage the isolated remaining pump power signal with the amplified information signal into a next combined signal; and
amplifying the information signal of the next combined signal at a next stage doped fiber amplifier.

8. The method of claim 7 wherein the separated information signal is provided to an input port of an interstage network.

9. The method of claim 7 wherein a WDM device is used to separate the combined signal.

10. The method of claim 7 wherein a WDM device is used to combine the isolated amplified information signal with the remaining pump power signal into the next combined signal.
